(19) United States
(12) Patent Application Publication
(10) Pub. No.: US 2013/0073431 A1
(43) Pub. Date: Mar. 21, 2013

(54) Product Display For Wireless Load Control Devices

(71) Applicants: Eric Suro, Macungie, PA (US); Jeremy B. Kleinberg, Coopersburg, PA (US); Paul G. Lobo, Baltimore, MD (US); Michael A. Maholick, Nazareth, PA (US); Christian E. Murray, Baltimore, MD (US); Daniel Curtis Raneri, Orefield, PA (US); Nathan J. Stauber, Cornelius, NC (US); Matthew Joseph Swatsky, Allentown, PA (US)

(72) Inventors: Eric Suro, Macungie, PA (US); Jeremy B. Kleinberg, Coopersburg, PA (US); Paul G. Lobo, Baltimore, MD (US); Michael A. Maholick, Nazareth, PA (US); Christian E. Murray, Baltimore, MD (US); Daniel Curtis Raneri, Orefield, PA (US); Nathan J. Stauber, Cornelius, NC (US); Matthew Joseph Swatsky, Allentown, PA (US)

(73) Assignee: LUTRON ELECTRONICS CO., INC., Coopersburg, PA (US)

(21) Appl. No.: 13/422,420

(22) Filed: Mar. 16, 2012

Related U.S. Application Data
(60) Provisional application No. 61/454,007, filed on Mar. 18, 2011.

(51) Int. Cl. G06Q 30/06

(52) U.S. Cl. CPC G06Q 30/0623
USPC 705/26.61

(57) ABSTRACT

A merchandise display system presents a product for sale to a potential customer and allows the customer to control the product using their personal smart phone. The display system includes an electrical load and a load control device (i.e., the product for sale), which is electrically coupled to the electrical load and is operable to receive a wireless message for control of the electrical load. The display system may also include a scannable tag adapted to be scanned by the smart phone, such that the smart phone downloads a product control application in response to scanning the tag. The load control device controls the electrical load in response to the smart phone executing the product control application. Accordingly, the customer is able to simply download the product control application onto the smart phone, and then control the product by executing the product control application on the smart phone.

### CROSS-REFERENCE TO RELATED APPLICATIONS

This application claims benefit under 35 U.S.C. §119(e) of provisional U.S. patent application No. 61/454,007, filed Mar. 18, 2011, the disclosure of which is incorporated herein by reference.

### BACKGROUND OF THE INVENTION

1. Field of the Invention

The present invention relates to a merchandise display for presenting products for sale to a potential customer, and specifically, a merchandise display for wireless load control devices that may be controlled by a product control application executed on a smart phone of the potential customer.

2. Description of the Related Art

Load control devices, which may be used to control the power delivered from an AC power source to an electrical load, are offered for sale in retail stores. Such load control devices may include, for example, lighting control devices (such as wall-mounted dimmer switches and plug-in lamp dimmers), motor control devices, temperature control devices, motorized window treatments, and remote controls. To attract consumers to a particular brand of load control device, a retailer may employ a merchandise display system in the retail store. Such a display system may include a product display containing a user-removable plurality of load control devices that are packaged for sale. Such a display system may also include a demo lighting control device having a user-manipulatable actuator. The demo lighting control device is typically connected to a lighting load, such that user manipulation of the actuator affects the light intensity level of the lighting load.

Some load control devices are operable to transmit and receive wireless signals, such as radio-frequency (RF) or infrared (IR) signals. Such wireless load control devices may be controlled in response to commands originating from a WiFi-enabled smart phone (such as, for example, an iPhone® smart phone). There is a need for a merchandise display that allows a potential customer to more personally interact with the products for sale, for example, by controlling a lighting load using a smart phone in wireless communication with a load control device.

### SUMMARY OF THE INVENTION

According to an embodiment of the present invention, a method of presenting a product for sale to a potential customer comprises the steps of: (1) providing a demo product in a merchandise display; (2) executing a product control application on a smart phone of the potential customer; and (3) controlling the demo product in response to the execution of the product control application on the smart phone. The method may further comprise the step of providing a scannable tag adapted to be scanned by the smart phone, such that the product control application is downloaded onto the smart phone in response to scanning the tag. In addition, the demo product may be operable to receive a wireless message for control of the demo product, and may comprise, for example, a dimmer switch for control of a lighting load.

In addition, a merchandise display system for presenting a product for sale to a potential customer having a smart phone is also described herein. The display system comprises an electrical load and a load control device electrically coupled to the electrical load for controlling the electrical load. The load control device is operable to receive a wireless message for control of the electrical load. The display system also comprises a router operable to communicate with the smart phone, such that the load control device controls the electrical load in response to the smart phone. The display system may also comprise a scannable tag adapted to be scanned by the smart phone, such that the smart phone downloads a product control application in response to scanning the tag.

Other features and advantages of the present invention will become apparent from the following description of the invention that refers to the accompanying drawings.

### BRIEF DESCRIPTION OF THE DRAWINGS

The invention will now be described in greater detail in the following detailed description with reference to the drawings in which:

FIG. 1 is an example front view of a product display for wireless load control devices according to the present invention;

FIG. 2 is a simplified block diagram of electrical components of the product display of FIG. 1;

FIG. 3 is a simplified flowchart of a product display interaction procedure completed by a user to interact with the product display of FIG. 1; and

FIG. 4 is an example screenshot that may be provided on a smart phone for controlling one of the wireless load control devices of the product display of FIG. 1.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

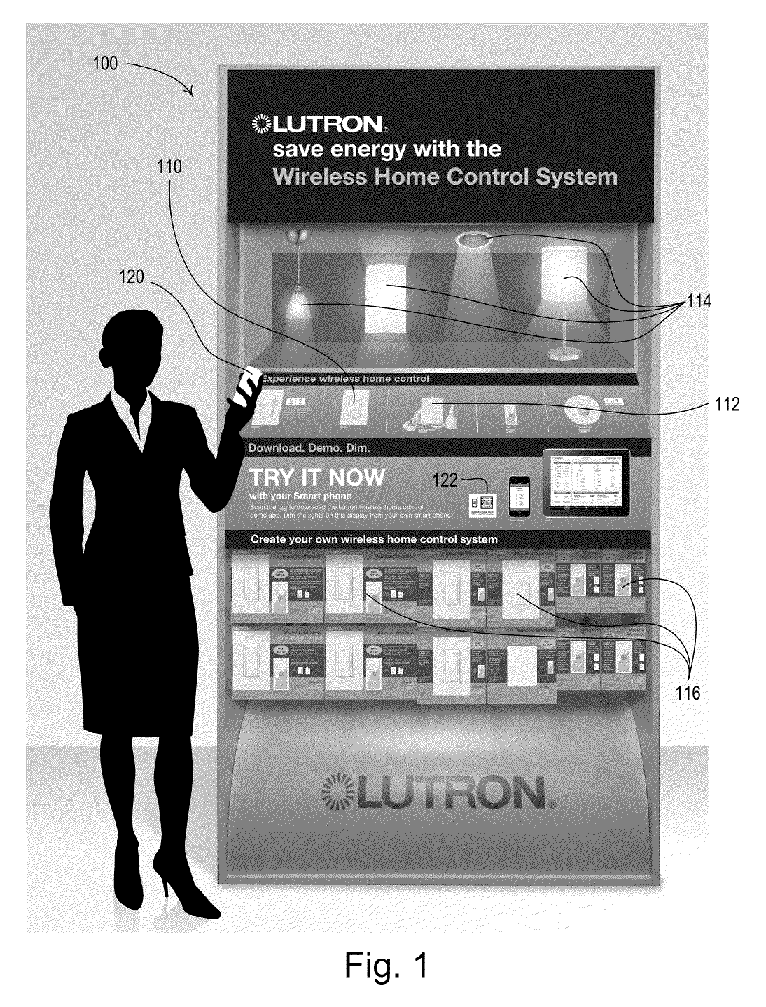

FIG. 1 is an example front view of a product display 100 (i.e., a merchandise display system) for wireless load control devices, such as, lighting control devices (e.g., dimmer switches) according to an embodiment of the present invention. The product display 100 comprises one or more demo products, such as, for example, a wall-mountable dimmer switch 110 and a plug-in dimmer switch 112 as shown in FIG. 1. The product display 100 further comprises one or more lighting loads 114, two of which are electrically coupled to the dimmer switches 110, 112, such that a user may actuate one of the dimmer switches to control a respective one of the lighting loads and thus interact with the product before purchasing the product. A plurality of packaged load control devices 116 that are available for purchase are also provided on the product display 100.

Alternatively, the product display 100 may include another type of load control device, such as, for example, a motor control device for controlling a motor load (such as a ceiling fan or an exhaust fan), a switching device for turning one or more appliances on and off, an electronic dimming ballast for a fluorescent lamp, a driver for a light-emitting diode (LED) light source, a screw-in luminaire that includes a light source and an integral load regulation circuit, a motorized window treatment, a thermostat for a heating and/or cooling system, a temperature control device for controlling a setpoint temperature of an HVAC system, an air conditioner, a compressor, an electric baseboard heater controller, a controllable damper, a humidity control unit, a dehumidifier, a water heater, a pool pump, an audio-visual (A/V) control device, a security control device, and a home automation control device. In addition, the product display 100 may comprises one or more wireless transmitters for sale, such as, for example, an occupancy sensor, a vacancy sensor, a daylight sensor, a temperature sensor, a humidity sensor, a security sensor, a proximity sensor, a keypad, a battery-powered remote control, a timeclock, an audio-visual control, and a central control transmitter.

According to an embodiment of the present invention, the user of the product display 100 (i.e., a potential customer) uses their personal smart phone 120 to interact with one of the demo products of the product display, e.g., the dimmer switch 110, and to thus adjust the intensity of the controlled lighting load 114. The smart phone 120 may comprise, for example, an iPhone® smart phone, an iPad® hand-held tablet computing device, an Android® smart phone or tablet, or a Blackberry® smart phone. The smart phone 120 may include a global positioning system (GPS) feature for providing data regarding the location of the phone. The smart phone 120 is able to connect to the Internet to download a product control application, for example, via a mobile connection or via a WiFi connection (i.e., the smart phone may be WiFi-enabled). The user then causes the smart phone 120 to execute the downloaded product control application in order to control the dimmer switch 110 in the product display 100. The product display 100 comprises a scannable tag 122, for example, a two-dimensional matrix barcode, such as, for example, a quick response (QR) code or a Microsoft® tag, to facilitate the download of the product control application.

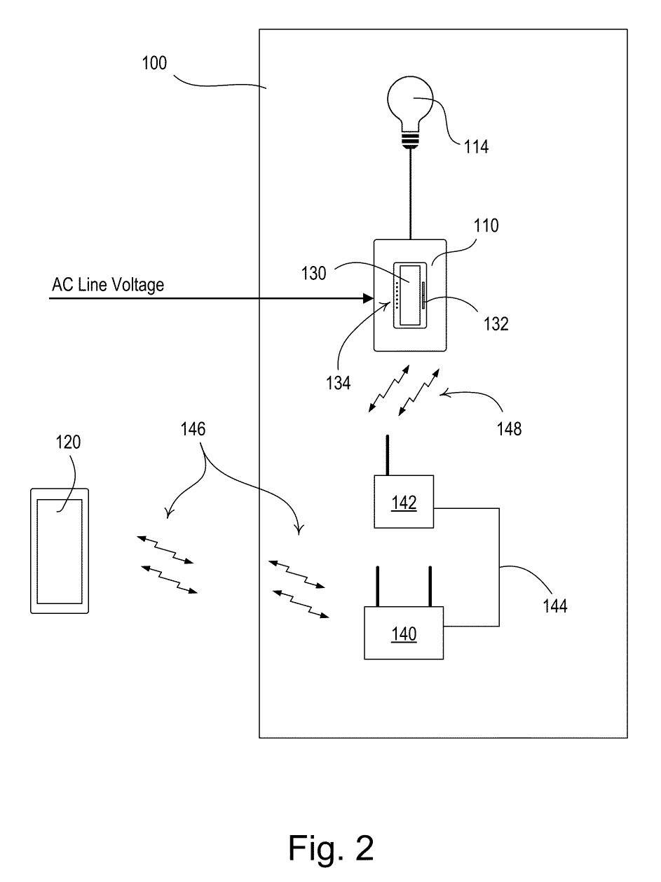

FIG. 2 is a simplified block diagram of the electrical components of the product display 100. The dimmer switch 110 is coupled between one of the lighting loads 114 and an alternating-current (AC) power source that provides an AC mains line voltage. The dimmer switch 110 is operable to adjust the amount of power delivered to the lighting load 114 and thus the intensity of the lighting load. The dimmer switch 110 may comprise a toggle actuator 130 (e.g., a pushbutton) for turning the lighting load 114 on and off, an intensity adjustment actuator 132 (e.g., a rocker switch) for adjusting the intensity of the lighting load, and a linear array of visual indicators 134 (e.g., light-emitting diodes) for providing feedback of the present intensity of the lighting load.

The product display 100 comprises a wireless router 140 and a wireless dimming control module 142, which are electrically coupled together via a wired Ethernet link 144. The wireless router is operable to receive digital messages from the smart phone 120 via RF signals 146 (e.g., a WiFi link) and to transmit corresponding digital messages to the wireless dimming control module 142 via the Ethernet link 144. The wireless dimming control module 142 then transmits digital messages to the dimmer switch 110 via RF signals 148, such that the dimmer switch then adjusts the intensity of the controlled lighting load 114 in response to the received digital messages. The product display 100 could also comprise a visual display (not shown) for displaying information regarding, for example, the energy savings achieved as the dimmer switch 110 dims the controlled lighting load 114. The smart phone 120 is also operable to receive wireless messages from the wireless router 140 regarding the status of the lighting load 114. The smart phone 120 may be operable to display information regarding the energy savings achieved by the dimmer switch 110.

Alternatively, the wireless router 140 and the wireless dimming control module 142 could be implemented as a single wireless routing device. In addition, the wired Ethernet link 144 could alternatively be implemented as a wireless communication link (e.g., a WiFi link) or any suitable communication link.

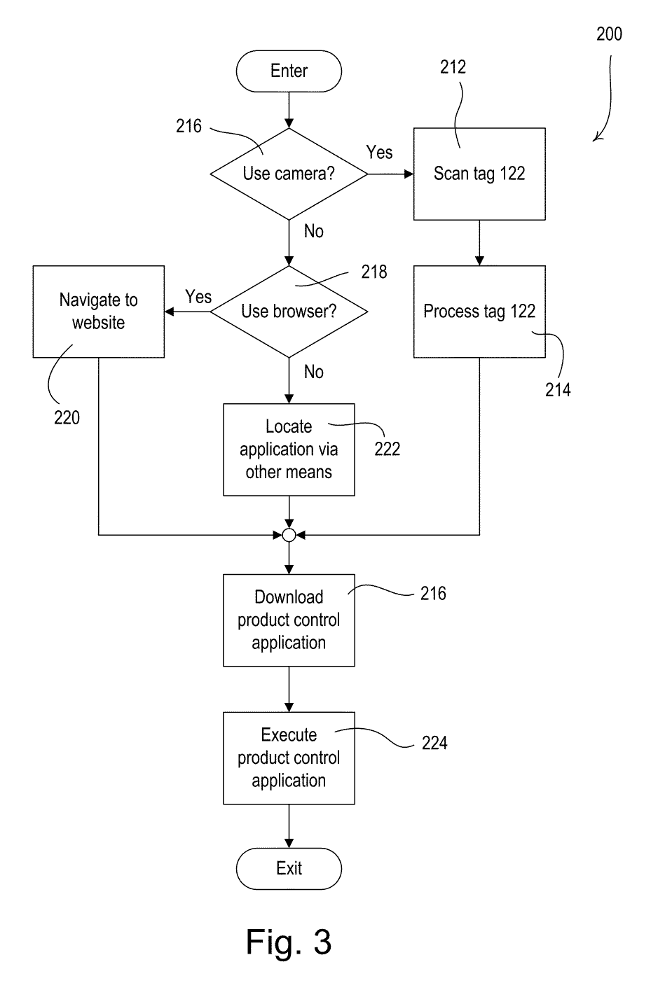

FIG. 3 is a simplified flowchart of a product display interaction procedure 200 completed by the user to interact with the product display 100. If the smart phone 120 includes a camera and the user would like to scan the tag 122 at step 210, the user scans the tag at step 212 by taking a picture of the matrix barcode with the camera of the smart phone. The smart phone 120 then processes the tag 122 (i.e., the matrix barcode) at step 214 using a barcode reader application to determine an Internet location of the product control application, and then download the product control application from the Internet location determined from the matrix barcode at step 216. Accordingly, the user is able to easily download the product control application to their smart phone 120 at the store in which the product display 100 is located by scanning the tag 122 using a scanner application on the smart phone. Alternatively, the tag 122 (i.e., the matrix barcode) could be printed in a printed publication (e.g., a magazine, a brochure, or a catalog), such that the user is able to download the product control application before coming to the store in which the product display 100 is located. Mobile tagging (i.e., the process of scanning matrix barcodes and tags with camera phones) is described in greater detail in U.S. Pat. No. 6,993,573, issued Jan. 31, 2006, entitled AUTOMATIC ACCESS OF INTERNET CONTENT WITH A CAMERA-ENABLED CELL PHONE, the entire disclosure of which is hereby incorporated by reference.

If the user wants to use a browser on the smart phone 120 to locate the product control application at step 218, the user could navigate to a webpage of the manufacturer of the dimmer switches 110, 112 using the browser on the smart phone 120 at step 220 in order to download the product control application at step 216 (i.e., without scanning the tag 122). If the user does not want to use the browser at step 218, the user could use an alternate means to locate the product control application at step 222. For example, the user could enter a product code or a store code into the scanner application on the smart phone 120 to download the product control application.

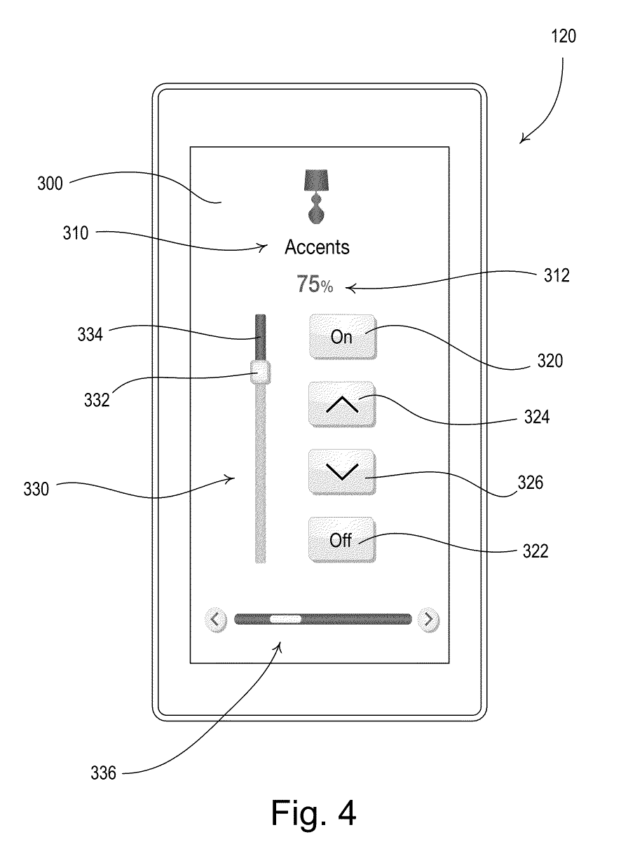

After downloading the product control application to the smart phone 120, the user executes the product control application on the smart phone at step 224. FIG. 4 is an example screenshot 300 that may be provided on the smart phone 120 when executing the product control application. The screenshot 300 includes a name field 310 for displaying a name of the lighting load 114 presently being controlled and an intensity field 312 for displaying the present intensity of the controlled lighting load 114. The smart phone 120 displays a plurality of “soft” buttons and controls for the user to actuate to control the lighting load 114. As shown in FIG. 3, the smart phone 120 displays an “On” button 320 for turning the lighting load 114 on to full intensity (e.g., 100%), an “Off' button 322 for turning the lighting load 114 off, a “Raise” button 324 for raising the intensity of the lighting load 114 by a predetermined amount, and a “Lower” button” 326 for lowering the intensity of the lighting load 114 by a predetermined amount. In addition, the smart phone 120 displays a virtual slider control 330 having an actuator knob 332 positioned along an elongated vertical slot 334. The user touches the actuator knob 332 and slides the knob up and down to respectively raise and lower the intensities of the lighting load 114. The smart phone 120 additionally displays a scroll bar 336 that is moved horizontally to cause the smart phone 120 to control the other lighting loads 114 of the product display 100. Other screenshots could be generated by the product control application on the smart phone 120 to allow for control of the lighting loads 114.

In response to actuations of the displayed soft buttons, the smart phone 120 transmits a first wireless digital message to the wireless router 140 via the RF signals 146. The first wireless digital message includes a command for controlling the lighting load 114. The wireless dimming control module 142 transmits a second wireless digital message to the dimmer switch 110 via the RF signals 148 in response to the wireless router 140 receiving the first wireless message. The dimmer switch 110 then adjusts the intensity of the lighting load 114 in response to the command included in the second wireless message, such that the dimmer switch 110 controls the lighting load 114 in response to actuations of the soft buttons of the smart phone 120.

The first wireless message transmitted by the smart phone 120 includes a product display address that may be unique to the specific product display 100, and the second wireless message transmitted by the wireless dimming control module 142 includes a demo product address that is unique for each of the demo products in the display. According to an embodiment of the present invention, the smart phone 120 acquires the product display address from the data retrieved from the scannable tag 122. Alternatively, the smart phone 120 could receive the product display address from the wireless router 140, or could determine the product display address from the GPS location data of the store in which the product display 100. According to an alternate embodiment, the product display address is not unique to each product display 100 and may be included with the downloaded product control application. A plurality of product displays located in retail stores in different locations all have the same default product display address, such that the smart phone 120 is instantly ready to control the dimmer switch 110 of the product display 100 upon downloading the product control application (i.e., without any additional programming or configuration steps).

While the present invention has been described with the smart phone 120 communicating directly with the wireless router 140 via the WiFi link, the smart phone 120 could alternatively communicate with the wireless router 140 using cellular communications, for example, via the Internet through a cloud server managed by the manufacturer of the products in the product display 100. For example, when the user scans the scannable tag 122 with the smart phone 120, the browser on the smart phone could launch a web page that is hosted on the cloud server and display screens similar to those of the product control application for controlling the lighting load 114. Therefore, the user does not need to download the product control application onto the smart phone 120 and the wireless router 140 could simply be a wired router. Alternatively, the web page could be hosted on a device in the product display 100, for example, the wireless dimming control module 142, and the smart phone 120 could communicate directly with the wireless dimming control module 142 via the wireless router 140 and the WiFi link.

The cloud server could use the GPS location data from the smart phone 120 to ensure that the user is located within the store of the product display 100 before controlling the lighting load 114. Alternatively, the smart phone 120 could verify the presence of the WiFi link of the wireless router 140 (i.e., specific to the store in which the product display 100 is located) before the cloud server controls the lighting load 114.

The wireless dimming control module 142 could also monitor the operation of the dimmer switch 110 and the plug-in dimmer switch 112 and transmit information regarding the status and usage of the product display 100. For example, the wireless dimming control module 142 could transmit a digital message to the cloud server if one of the lighting loads 114 is burnt out or otherwise failed, and the cloud server could send an email or a text message to a manager of the store in which product display 100 is located so that the lighting load can be serviced. In addition, the wireless dimming control module 142 could transmit a digital message if one or more of the lighting loads 114 are left on afterhours. Further, the wireless dimming control module 142 could transmit information regarding the usage of the product display 100 to the cloud server, such that the retailer or manufacturer could understand what merchandising techniques have better stopping power.

Wireless load control devices are described in greater detail in commonly-assigned U.S. Pat. No. 5,905,442, issued on May 18, 1999, entitled METHOD AND APPARATUS FOR CONTROLLING AND DETERMINING THE STATUS OF ELECTRICAL DEVICES FROM REMOTE LOCATIONS; U.S. Pat. No. 6,803,728, issued Oct. 12, 2004, entitled SYSTEM FOR CONTROL OF DEVICES; U.S. patent application Ser. No. 12/033,223, filed Feb. 19, 2008, entitled COMMUNICATION PROTOCOL FOR A RADIO-FREQUENCY LOAD CONTROL SYSTEM; and U.S. Provisional Application No. 61/384,073, filed Sep. 17, 2010, entitled DYNAMIC KEYPAD FOR CONTROLLING ENERGY-SAVINGS SETTINGS OF A LOAD CONTROL SYSTEM; the entire disclosures of which are hereby incorporated by reference.

While the present invention has been described with reference to the product display 100 for wireless load control devices, the concepts of the present invention can be be used in a product display for a wide variety of electronic device. Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method of presenting a product for sale to a potential customer having a smart phone, the method comprising the steps of:
providing a demo product in a merchandise display;
executing a product control application on the smart phone; and
controlling the demo product in response to the execution of the product control application on the smart phone.

2. The method of claim 1, further comprising:
downloading the product control application onto the smart phone prior to the step of executing a product control application on the smart phone.

3. The method of claim 2, further comprising:
providing a scannable tag adapted to be scanned by the smart phone, such that the product control application is downloaded onto the smart phone in response to scanning the tag.

4. The method of claim 3, wherein the smart phone is operable to determine a product display address for controlling the demo product from data retrieved from the scannable tag.

5. The method of claim 3, wherein the scannable tag comprises a two-dimensional matrix barcode, and the barcode is scanned by taking a picture of the barcode with the smart phone.

6. The method of claim 3, wherein the scannable tag is provided on the merchandise display.

7. The method of claim 3, wherein the scannable tag is provided on a printed publication.

8. The method of claim 1, wherein the demo product is operable to receive a wireless message for control of the demo product.

9. The method of claim 8, wherein the demo product comprises a dimmer switch operable to control the intensity of a lighting load.

10. The method of claim 9, wherein the step of controlling the demo product further comprises the steps of:
transmitting a first wireless message from the smart phone to a wireless router of the merchandise display;
transmitting a second wireless message to the dimmer switch in response to the wireless router receiving the first wireless message; and
the dimmer switch adjusting the intensity of the lighting load in response to receiving the second wireless message.

11. The method of claim 10, wherein the smart phone is operable to transmit the first wireless message to the wireless router via a WiFi link.

12. The method of claim 10, wherein the smart phone is operable to transmit the first wireless message to the wireless router via the Internet.

13. The method of claim 10, wherein the smart phone is operable to determine a product display address for controlling the demo product from the wireless router.

14. The method of claim 1, wherein the step of executing a product control application on the smart phone comprises launching a browser displaying screens for controlling the demo product.

15. The method of claim 14, wherein the smart phone is operable to communicate with a cloud server via the Internet to display the screens for controlling the demo product on the browser.

16. The method of claim 14, wherein the smart phone is operable to communicate with a router in the merchandise display via a WiFi link to display the screens for controlling the demo product on the browser.

17. The method of claim 1, further comprising:
verifying that the smart phone is located within a store of the merchandise display prior to controlling the demo product.

18. The method of claim 17, wherein the step of verifying that the smart phone is located within a store of the merchandise display further comprises using GPS location data from the smart phone to verify that the smart phone is located within a store of the merchandise display.

19. The method of claim 17, wherein the step of verifying that the smart phone is located within a store of the merchandise display further comprises using the presence of a WiFi link of a wireless router in the merchandise display to verify that the smart phone is located within a store of the merchandise display.

20. The method of claim 1, further comprising:
transmitting information regarding the status and/or usage of the product display.

21. The method of claim 1, wherein the smart phone is operable to determine a product display address for controlling the demo product from GPS location data of a store of the merchandise display.

22. A merchandise display system for presenting a product for sale to a potential customer having a smart phone, the display system comprising:
an electrical load;
a load control device electrically coupled to the electrical load for controlling the electrical load, the load control device operable to receive a wireless message for control of the electrical load; and
a router operable to communicate with the smart phone, such that the load control device controls the electrical load in response to the smart phone.

23. The display system of claim 22, wherein the electrical load comprises a lighting load and the load control device comprises a dimmer switch operable to control the intensity of the lighting load.

24. The display system of claim 23, wherein the router comprises a wireless router operable to receive a first wireless message from the smart phone.

25. The display system of claim 24, further comprising:
a wireless dimming control module coupled to the wireless router via a communication link, the wireless dimming control module operable to transmit a second wireless message to the dimmer switch in response to the wireless router receiving the first wireless message from the smart phone;
wherein the dimmer switch adjusts the intensity of the lighting load in response to receiving the second wireless message from the wireless dimming control module.

26. The display system of claim 25, wherein the communication link comprises a wired Ethernet link.

27. The display system of claim 25, wherein the communication link comprises a wireless communication link.

28. The display system of claim 23, wherein the router is operable to receive a first wireless message directly from the smart phone, the router operable to transmit a second wireless message directly to the dimmer switch in response to receiving the first wireless message from the smart phone;
wherein the dimmer switch adjusts the intensity of the lighting load in response to receiving the second wireless message from the wireless routing device.

29. The display system of claim 22, further comprising:
a scannable tag adapted to be scanned by the smart phone;
wherein the smart phone is operable to download a product control application for controlling the lighting load via the router.

30. The display system of claim 29, wherein the scannable tag comprises a two-dimensional matrix barcode, and the barcode is scanned by taking a picture of the barcode with the smart phone.
